(19) United States
(12) Patent Application Publication
(10) Pub. No.: US 2014/0149540 A1
(43) Pub. Date: May 29, 2014

(54) DECENTRALIZED ADMINISTRATION OF ACCESS TO TARGET SYSTEMS IN IDENTITY MANAGEMENT

(71) Applicant: ORACLE INTERNATIONAL CORPORATION, Redwood Shores, CA (US)

(72) Inventor: Shyam Sundar Rao Mankala, Bangalore (IN)

(73) Assignee: Oracle International Corporation, Redwood Shores, CA (US)

(21) Appl. No.: 13/869,966

(22) Filed: Apr. 25, 2013

Related U.S. Application Data
(60) Provisional application No. 61/729,425, filed on Nov. 23, 2012.

(51) Int. Cl. H04L 12/24

(52) U.S. Cl. CPC H04L 41/00
USPC 709/217

(57) ABSTRACT

An aspect of the present invention provides for decentralized administration of access to target systems. In an embodiment, an identity link system is provided between an identity manager and target systems, with the identity manager being required to interface with the identity link to access the target systems. The identity link maintains all the connector information for accessing the target systems such that the information need not be provided to the identity manager. Accordingly, the identity link can be co-located with target systems, for example in a remote data centre, such that access to the target systems can be controlled by administrators of the remote data centre, thereby providing decentralized administration.

### RELATED APPLICATIONS

The present applications is non-provisional of and claims priority from co-pending US provisional application entitled, “Decentralized connector management of application providers operating on-premise or off-premise deployments”, Application No. 61/729,425, filed on: 23 Nov. 2012, First Named Inventor: Shyam Sundar Rao Mankala, and is incorporated in its entirety herewith.

### BACKGROUND OF THE INVENTION

1. Technical Field

The present disclosure relates to enterprise systems and more specifically to decentralized administration of access to target systems in identity management.

2. Related Art

In the context of enterprise systems, identity generally refers to the information that identifies (uniquely or generally) a user. By providing some of such information, a user establishes that s/he is who he purports to be, which forms the basis for permitting access to various resources available on the enterprise systems. Examples of identity information used for permitting access include user name and password combinations, biometric based information, digital signatures, etc. Identity commonly includes other information related to the user such as the name, age, department, location, etc.

Enterprises often contain multiple target systems, with each target system maintaining portions of identity information related to corresponding groups of users (accessing the resources). For example, an enterprise resource planning (ERP) system may maintain identity information of users permitted to perform corresponding ERP related actions (e.g., creating purchase orders). A Lightweight Directory Access Protocol (LDAP) server may store identity information related to users of applications designed to authenticate/access the resources based on LDAP protocol.

Identity management systems (IMS) are generally used for central control and coordination of the identity information stored in different and disparate target systems (in particular, when there is overlap among the groups of users maintained in different target systems). Such IMSs provide users the ability to manage their respective identity information from a central system, while providing the administrators to potentially easily synchronize the identity information across different target systems.

However, for many such tasks, IMSs need to be provided access to the corresponding target systems. Providing access typically entails configuration of various access parameters corresponding to different target systems (e.g., protocol supported by the target system, the IP address and ports to be used for accessing the target systems, etc.). Access may also require provisioning of appropriate software code/instructions for some of the target systems (e.g., legacy systems). Information such as the access parameters and code, specifically required for establishing connection may be referred to as connector information.

It is generally desirable that the facility of administrating access be suitable in corresponding environments.

### BRIEF DESCRIPTION OF THE DRAWINGS

Example embodiments of the present invention will be described with reference to the accompanying drawings briefly described below.

FIG. 1A is a block diagram illustrating an example environment in which several aspects of the present invention can be implemented.

FIG. 1B is a block diagram illustrating the manner in which an identity manager is provided access to target systems in multiple data centers in one embodiment.

FIG. 2 is a block diagram illustrating the manner in which administration of access to target systems in multiple data centers is decentralized according to an aspect of the present invention.

FIG. 3 is a flow chart illustrating the manner in which an identity link in a remote data center facilitates an identity manager to manage identity information according to an aspect of the present invention.

FIG. 4 is a block diagram illustrating the manner in which identity managers and identity links can be deployed in multiple data centers for providing decentralized administration of access to target systems in one embodiment.

FIG. 5 is a block diagram illustrating the details of a digital processing system in which various aspects of the present invention are operative by execution of appropriate software instructions.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### 1. Overview

An aspect of the present invention provides for decentralized administration of access to target systems. In an embodiment, an identity link system is provided between an identity manager and target systems, with the identity manager being required to interface with the identity link to access the target systems. The identity link maintains all the connector information for accessing the target systems such that the information need not be provided to the identity manager. Accordingly, the identity link can be co-located with target systems, for example in a remote data centre, such that access to the target systems can be controlled by administrators of the remote data centre, thereby providing decentralized administration.

In operation, the identity manager sends to the identity link, an action request directed to a specific target system. The identity link establishes the requisite connection with the specific target system using the maintained corresponding connector information. The action specified in the received action request is sent on the established connection. The result of performance of the action is received from the target system and then forwarded (after appropriate conversion, if needed) to the identity manager.

Several aspects of the present invention are described below with reference to examples for illustration. However, one skilled in the relevant art will recognize that the invention can be practiced without one or more of the specific details or with other methods, components, materials and so forth. In other instances, well-known structures, materials, or operations are not shown in detail to avoid obscuring the features of the invention. Furthermore, the features/aspects described can be practiced in various combinations, though only some of the combinations are described herein for conciseness.

### 2. Example Environment

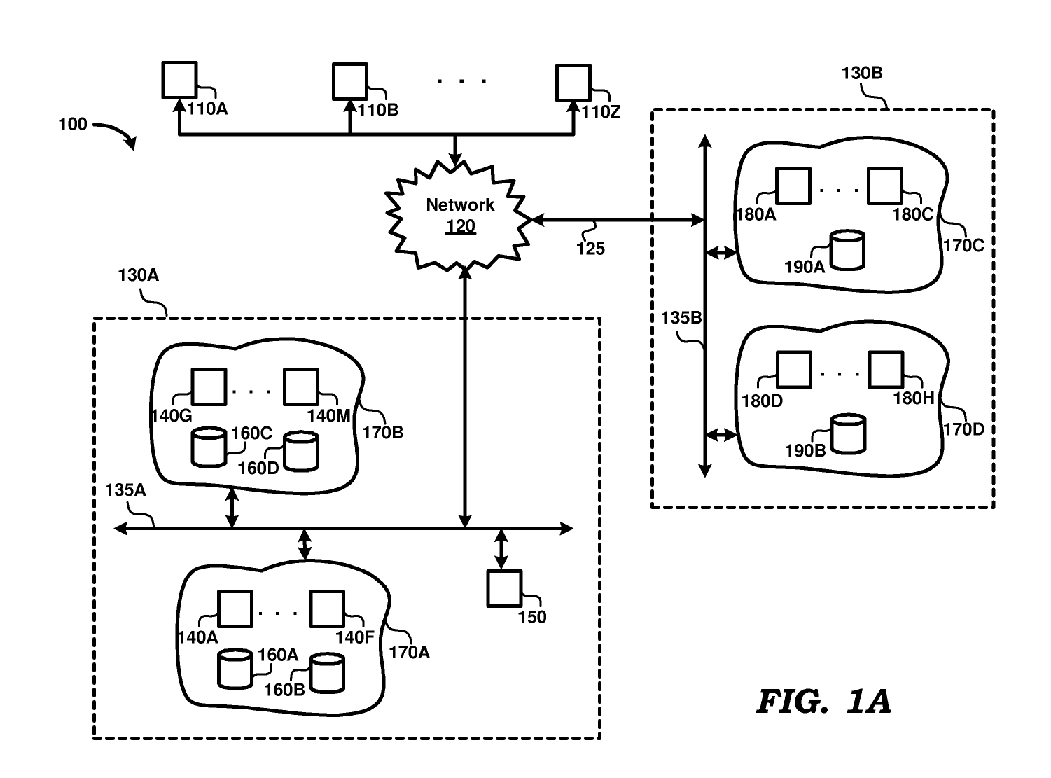

FIG. 1A is a block diagram illustrating an example environment (computing system 100) in which several aspects of the present invention can be implemented. The environment represents an enterprise maintaining groups of systems at multiple geographically different locations, commonly referred to as data centers. For illustration, computing system 100 is shown containing two data centers 130A-130B along with client systems 110A-110Z, and network 120. Data center 130A is shown containing server systems 140A-140M, Identity manager 150, and data stores 160A-160D, while data center 130B is shown containing server systems 180A-180H and data store 190A-190B.

Merely for illustration, only representative number/type of systems/data centers is shown in the Figure. Many environments often contain many more data centers, each in turn containing many more systems, both in number and type, and located geographically separately (but connected with each other via corresponding network paths such as 125) depending on the purpose for which the environment is designed. Each system/device of FIG. 1 is described below in further detail.

Network 120 provides connectivity between client systems 110A-110Z and systems in data centers 130A-130B. Network 120 may be implemented using protocols such as Transmission Control Protocol (TCP) and/or Internet Protocol (IP), well known in the relevant arts. In general, in TCP/IP environments, an IP packet is used as a basic unit of transport, with the source address being set to the IP address assigned to the source system from which the packet originates and the destination address set to the IP address of the destination system to which the packet is to be eventually delivered.

A (IP) packet is said to be directed to a destination system when the destination IP address of the packet is set to the (IP) address of the destination system, such that the packet is eventually delivered to the destination system by network 120. When the packet contains content such as port numbers, which specifies the destination application, the packet may be said to be directed to such application as well. The destination system may be required to keep the corresponding port numbers available/open, and process the packets with the corresponding destination ports. Network 120 may be implemented using any combination of wire-based or wireless mediums.

Each of client systems 110A-110Z represents a system such as a personal computer, workstation, mobile station, etc., used by users to generate (client) requests to enterprise applications executing in data centers 130A or 130B. The client requests may be generated using appropriate user interfaces. In general, a client system requests an application for performing desired tasks/services (such as accessing a resource hosted by the data center, invoking a service, etc.) and receives corresponding responses containing the results of performance of the requested tasks/services.

Each of data centers 130A-130B represents a corresponding group of heterogeneous systems (i.e., “nodes”) such as server systems, data stores, identity managers, etc., (connected by communication paths such as 135A and 135B) that can work together to provide various services to users using client systems 110A-110Z. The nodes of each data center is generally administered independently (by a corresponding group of users/administrators) based on the resources hosted by the data center. In some environments, the systems in different data centers (such as 130A and 130B) may be administered by unrelated business organizations.

Some of the typical (types of) nodes in a data center, such as data stores, server systems, and identify manager as relevant to the understanding of the present invention are described in detail below. However, a data center may contain more types and/or number (typically, in thousands) of nodes as will be apparent to one skilled in the relevant arts.

Each of data stores 160A-160D and 190A-190B represents a non-volatile storage facilitating storage and retrieval of a collection of data by one or more enterprise applications executing in data centers 130A-130B, in particular in server systems 140A-140M and 180A-180H (typically while processing various client/user requests). Some of the data stores may be implemented using relational database technologies and therefore provide storage and retrieval of data using structured queries such as SQL (Structured Query Language). Other data stores may be implemented as file stores providing storage and retrieval of data in the form of one or more files organized as one or more directories, as is well known in the relevant arts.

Each of server systems 140A-140M and 180A-180H represents a server, such as a web/application server, executing applications capable of performing tasks requested by users using client systems 110A-110Z. In response to receiving a client request from a client system, a server system performs the tasks specified in the request and sends the result of performance of the tasks to the requesting client system. The server system may use data stored internally (for example, in a non-volatile storage/hard disk within the server), external data (for example, data stores 160A-160D or 190) and/or data received from other sources (e.g., from the user) in performing such tasks.

It may be appreciated that the nodes of a data center such as 130A may be organized as sub-systems 170A-170D (each containing a corresponding subset of nodes) providing different classes of (typically distinct) services. For example, one of the sub-systems 170A may correspond to an ERP (Enterprise Resource Planning) system executing various enterprise applications that provide various ERP related services (that is enabling users to perform ERP related actions/tasks such as creating purchase orders), while sub-system 170B may correspond to an collaborative suite that provides various collaboration related services (e.g., work together as a team, communicate with other users, etc.).

Similarly, sub-systems 170C and 170D in data center 130B may provide other classes of services to the users using client systems 110A-110Z. For convenience, it is assumed that each of nodes in a data center belongs to a single sub-system (in other words, the subsets of nodes in the data center do not overlap). However, in alternative embodiments, the data center may contain nodes executing applications providing services of different classes, and accordingly could be included in more than one sub-system, as will be apparent to one skilled in the relevant arts.

As noted in the Background Section, the access to such services provided by the data centers is based on verification of the identity of the users (using client systems 110A-110Z). Such verification may be performed before the performance of any tasks specified in the client requests received from the users. In one embodiment, the verification is performed based on the class of requested tasks/services by the corresponding sub-systems. Thus, for an ERP related task, the verification is performed by one or more nodes/servers in sub-system 170A, while for a collaborative task, the verification is performed by nodes in sub-system 170B.

As noted in the Background Section, verification of users is generally performed based on the identity information stored in one or more target systems in each sub-system. As such, an enterprise application executing in a server system may collect identity information from the user and forward the collection identity information to a corresponding target system (of the sub-system to which the server system belongs), with the target system then verifying the user based on such collected identity information. For performing the verification, each target system may maintain the identity information related to corresponding groups of users having access to the resources of the corresponding sub-system.

For illustration, in the below description, it is assumed that server system/ERP server 140A is a target system in sub-system 170A that maintains identity information on the group of ERP users, data store/directory server 160C is target system in sub-system 170B that facilitates identity information to be accessed using LDAP protocol, server system/Unix server 180B is a target system in sub-system 170C, and data store/database server 190B is a target system in sub-system 170D that maintains information on the group of collaborative users. It may be appreciated that there may be overlap in the different groups of users, and accordingly, it may be desirable that administrators (and also the users) of the data centers/sub-systems be provided a centrally managed identity information.

Identity manager 150 represents a system such as a server that facilitates the central control and coordination (management) of the identity information stored in different target systems of an organization. Centralized management typically refers to providing a common repository storing the identity information of all the users having access to the resources of an enterprise and ensuring that the information stored in the repository and the different target systems are consistent. Administrators and/or users may modify the identity information in the repository (either by manually changing the information or by downloading the information from a target system) and then synchronize the modified information with other target systems. Such synchronization (or any other “management action”) may be performed manually (in response to an administrator request) or automatically (according to a pre-defined schedule). An identity manager may be implemented by using Oracle Identity Management™ software, available as part the Oracle Fusion Middleware™ 11g software from Oracle Corporation™, the intended assignee of the present invention.

As noted in the Background section, identity manager 150 needs to be provided access to the target systems in data centers 130A-130B. The manner in which such access to target systems may be provided is described below with examples. To better understand the features of the present invention, an alternative approach to providing access to target systems is described first, followed by the inventive approach.

### 3. Alternative Approach

FIG. 1B is a block diagram illustrating the manner in which an identity manager is provided access to target systems in multiple data centers in one embodiment. Each of the target systems (corresponding to different sub-systems 170A-170D) in data centers 130A-130B is shown in the Figure along with identity manager 150.

An administrator of identity manager 150 (or data center 130A) may configure the connector information required for connecting to different target systems. As noted above, the connector information may contain software code/instructions and/or access parameters (such as IP address, port number, protocol, the user identifier and password, etc.) that would be used to establish connection with the corresponding target system. Data representing action requests and corresponding responses may be exchanged once the connection is established. In other words, the connector information facilitates identity manager 150 to access the desired target systems and manage the identity information maintained in the target systems (and accordingly the enterprise).

Thus, an administrator may configure the connector information for accessing the two local systems 140A and 160C (shown as two circles within identity manager 150 block), and also for accessing the two remote systems 180B and 190B of data center 130B (shown as two triangles within identity manager 150 block). Though the connector information is shown within identity manager 150, in alternative embodiments, the connector information for different target systems (within both data centers 130A-130B) may be maintained external to the identity manager, for example, in a data store (such as 160A-160D) in data center 130A.

There are several disadvantages to the above noted alternative approach, in particular, when providing access to target systems located in another/remote data center (such as 130B). For example, there may be security concerns with keeping a number of ports (corresponding to the number/type of target systems) open in the remote data center for receiving requests (via path 125/135B) from identity manager 150, and with providing access parameters to the identity manager when the data centers are maintained by different business organizations and/or when the parameters are frequently changed. Furthermore, such an approach may not be feasible in “hybrid” data centers (where an organization has outsourced hosting of some of the resources to a third-party data center) or when some of the data centers host resources for multiple business organizations (“multi-tenancy”), etc.

It may be desirable that the administration of access to target systems be more decentralized, while still enabling the identity manager to centrally control and coordinate the identity information of the enterprise. Several aspects of the present invention decentralize the administration of access to target systems as described below with examples.

### 4. Decentralizing Administration of Access to Target Systems

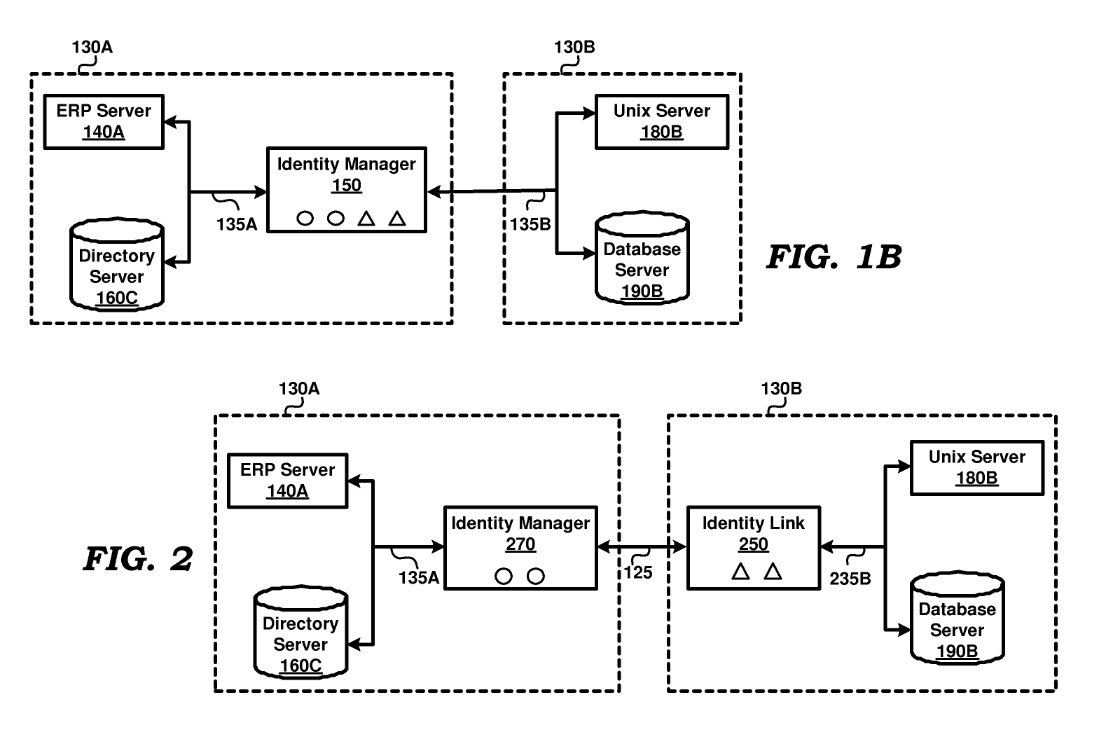

FIG. 2 is a block diagram illustrating the manner in which administration of access to target systems in multiple data centers is decentralized according to an aspect of the present invention. Similar numbers are used to represent corresponding blocks of FIGS. 1B and 2 and hence descriptions of such portions are not repeated for conciseness.

Identity link 250, provided according to several aspects of the present invention, represents a system (present in a remote data center such as 130B) that is designed to co-operate with identity manager 270 for managing the identity information of the enterprise. In particular, identity link 250 maintains the connector information for the target systems that are present locally within in the remote data center. Thus, identity link 250 is shown maintaining the two connector information (represented as triangles) for the target systems 180B and 190B in data center 130B. The connector information of identity link 250 is commonly specified by administrators of data center 130B.

Identity manager 270 represents a system similar to identity manager 150 of FIG. 1 that facilitates the central control and coordination of the identity information stored in different target systems. However, identity manager 270 is designed to access only the local (present within data center 130A) target systems directly, that is by establishing a connection with the desired target system using the connector information (represented as circles) maintained in the identity manager. For remote target systems within data center 130B, identity manager 270 is designed to interface with identity link 250 for accessing (and for performing any management actions in) the desired target system.

It may be appreciated that the connector information (circles) in identity manager 270 are typically configured by administrators of data center 130A, while the connector information (triangles) in identity link 250 are configured by administrators of data center 130B. Thus, the administration of access to target systems is decentralized. It may be further appreciated that by using identity link 250, only a single port needs to be kept open and that access parameters (of the remote target systems) need not be provided to the identity manager.

The manner in which identity link 250 may facilitate identity manager 270 to (access and) perform management actions is described below with examples.

### 5. Managing Identity Information

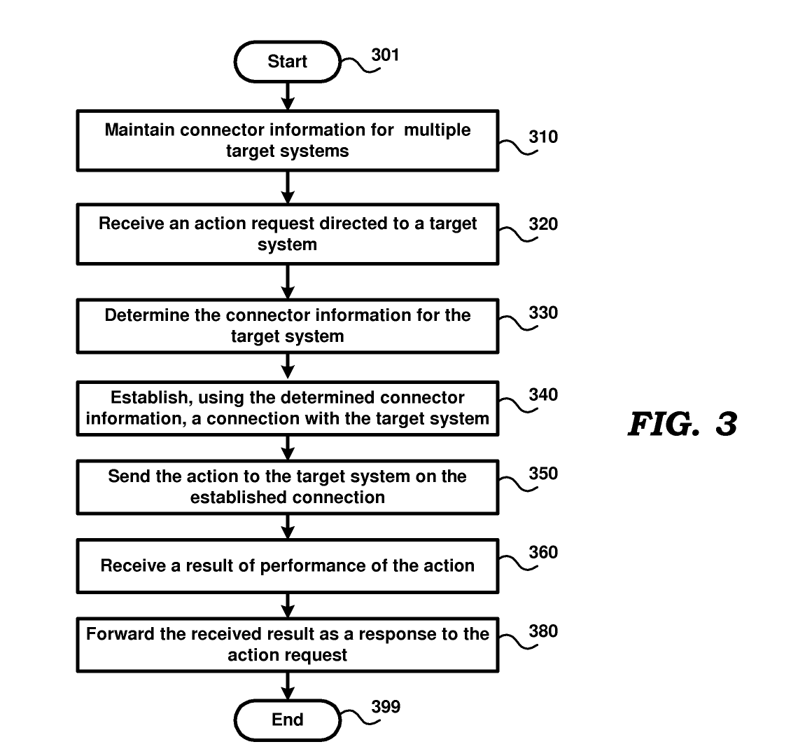

FIG. 3 is a flow chart illustrating the manner in which identity information is managed according to an aspect of the present invention. The flowchart is described with respect to the systems of FIG. 2 merely for illustration. However, the features can be implemented in other environments also without departing from the scope and spirit of various aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present invention. The flow chart begins in step 301, in which control immediately passes to step 310.

In step 310, identity link 250 maintains connector information for multiple target systems such as 180B and 190B within data center 130B. Identity link 250 may maintain such connector information internally in a non-volatile memory such as a hard disk or externally, for example, in data store 190B.

In step 320, identity link 250 receives (from identity manager 270) an action request directed to a target system (e.g. 180B) within data center 130B. The action request specifies a management action (e.g., synchronize, update, retrieve) related to identity management, and any necessary parameters or objects (portions of identity information) required for the performance of the management action.

In step 330, identity link 250 determines the connector information for the target system (specified in the action request). The determination may be performed by inspecting the connector information maintained in the step 310. In one embodiment, each target system is identified by a corresponding identifier, and as such the connector information is maintained associated with the identifiers. The determination of the specific connector information is then performed based on the identifier (of the target system) specified in the action request.

In step 340, identity link 250 establishes, using the determined connector information, a connection with the requested target system (e.g., 180B). Establishing a connection prepares the systems at either end to send/receive data packets, and is thus normally a pre-requisite for a target system to receive and process action requests. In one embodiment, identity link 250 send one or more requests containing the access parameters to the requested target system, and then processes the corresponding responses for establishing the connection. Identity link 250, in some cases, may execute software code/instructions specified as part of the connector information, for establishing the connection.

In step 350, identity link 250 sends the requested management action to the target system on the established connection. In step 360, identity link 250 receives a result of performance of the management action on the target system. In step 380, identity link 250, forwards the received result (after any required conversions) as a response to the action request. The forwarding and the conversions may be performed in a known way. The flowchart ends in step 399.

Thus, identity link 250 facilitates identity manager 270 to manage identity information maintained in different target systems, while also enabling the administration of access to such target systems to be decentralized. The operation of the various systems of FIG. 3 in accordance with some of the features described above, is illustrated below with examples.

### 6. Packet Format/Content

In one embodiment, the action requests (sent on path 125) are specified according to Representational State Transfer (REST) architecture based on Hypertext Transfer Protocol (HTTP), described in further detail in RFC 2616 entitled, “Hypertext Transfer Protocol—HTTP/1.1”. The payload/content of the action requests (and the corresponding responses) are specified according to (eXtensible Markup Language (XML). Some sample action requests that may be sent and the corresponding actions performed by identity link 250 are described in further detail in Appendix A.

Thus, for accessing a specific object/user data, identity manager 270 sends an action (HTTP GET) request having an URL such as “www.acme.com/targets/dba190/user/22”, where “www.acme.com” represents the domain name at which identity link 250 is accessible, “targets” is a pre-defined keyword (as noted in Appendix A), “dba190” represents an identifier of the specific target system (database server 190B) maintaining the user data, “user” indicates the object class (user) sought to be accessed in the target system, and “22” is a unique identifier of the user data object sought to be accessed in the target system.

In response to receiving the above action request, identity link 250 first identifies that the requested target system is database server 190B and determines corresponding connector information based on the maintained connector data. In one embodiment, the connector information for each target system contains corresponding software code (hereafter referred to as a “connector bundle”) implemented according to Java™ programming language. Each connector bundle is designed to interface with a corresponding target system, while providing the same application programming interface (API) to identity link 250. The API contains various procedures that may be invoked by identity link 250 for interfacing with the requested target system.

In one embodiment, identity link 250 invokes a single procedure (of the API) corresponding to the action request, with the database connector bundle then performing the below noted actions. As such, identity link 250 invokes a single object access procedure of the API to access the user data object having the identifier “22” on the target system “dba190” (database server 190B). However, in alternative embodiments, identity link 250 may be designed to invoke multiple procedures of the API for performing the various actions such as a first procedure for establishing the connection with the requested target system and then a second procedure for accessing the requested data object.

In response to the invocation of the object access procedure, the database connector bundle may send one or more requests on path 235B to establish a connection with database server 190B. For example, the database connector may send on path 235B, a request containing a local URL of the database server, the name of database maintaining information on a group of collaborative users, and a user name and password combination for accessing the database on the database server. The local URL, name of the database and the combination may be previously configured/specified by an administrator of datacenter 130B. Database server 190B may send (after authentication) a response indicating that the connection has been successfully established. In an embodiment, the requests/responses are sent and connection is established using JDBC (Java Database Connection), well known in the relevant arts.

Once the connection is successfully established, database connector bundle may send corresponding SQL queries on path 235B to access the requested data. For example, the database connector bundle may send the following SQL query:

SELECT*

FROM Users

WHERE UserId=22

Wherein “SELECT”, “*”, “FROM”, “WHERE” and “=” are keywords according to SQL, “Users” is the name of table storing the user data is stored in and “UserId” is a primary key of the “Users” table that uniquely identifies each row in the table.

In response to the above SQL query, database server 190B may send (to the database connector bundle on path 235B) the user data uniquely identified by the identifier “22”. The user data may be sent in any convenient format, for example, as binary data that can be understood by the database connector bundle. The database connector bundle may then convert the binary data into a common format (for example, as objects of pre-defined Java™ classes) and provide the result data in the common format to identity link 250 (as a result of invocation of the object access procedure. However, in alternative embodiments, the various connector bundles may be designed to convert the binary data into corresponding XML data, and thereafter provide the XML data as a result of invocation of the procedures.

Thus, assuming that the “Users” table contains the columns “Name” and “Department” in addition to the primary key “UserId”, the user data received from the database may be converted (by identity link 250) into the following portion of XML data:

<user>

<userid>22</userid>
<name>Debano</name>
<department>Production</department>

</user>

Identity link 250 then forwards (to identity manager 270) the XML data as a response to the action request noted above. Thus, identity manager 270 is enabled to access the identity information (user data) maintained on the remote target systems (such as database server 190B), while providing decentralized administration of different target systems used in identity management. Identity manager 270 may similarly perform other actions such as adding, updating, and deleting user data by sending appropriate action requests as noted in Appendix A.

Though the operation of an identity link is described above in the scenario of two data centers, it may be appreciated that many environments often contain more than two data centers. The manner in which identity managers and identity links may be deployed in such environments is described below with examples.

### 7. Deployment in Multiple Data Centers

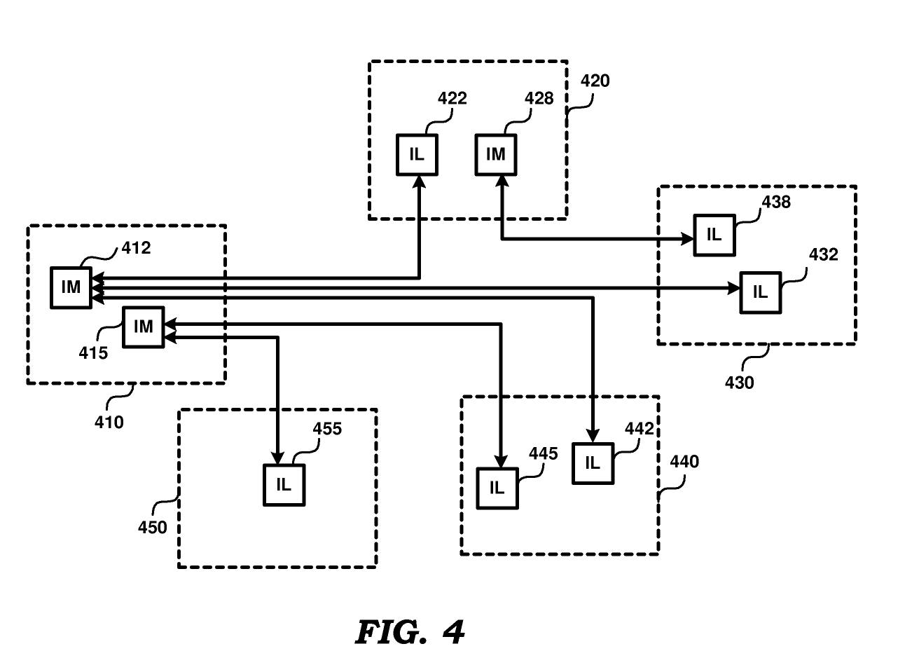

FIG. 4 is a block diagram illustrating the manner in which identity managers and identity links can be deployed in multiple data centers for providing decentralized administration of access to target systems in one embodiment. The block diagram is shown containing data centers 410, 420, 430, 440 and 450, with each data center in turn shown containing different identity managers (IMs) and identity links (ILs). Other nodes such as servers and data stores present in each of the data centers are not shown in FIG. 4 for clarity.

It may be appreciated that different deployments of IMs and ILs are shown in FIG. 4, depending on the different scenarios in which the identity information is sought to be managed. Some of the scenarios and their corresponding requirements along with the specific deployments satisfying such requirements are described in detail below.

In a line of business scenario, an enterprise has multiple data centers (410, 440 and 450) that are located at different geographical locations (countries) and are related to different lines of businesses. It may be accordingly be desirable that each line of business be provided the ability to manage access to their local target systems. IM 415 along with ILs 445 and 455 depict a deployment for the line of business scenario. IM 415 interfaces (by sending action requests and receiving corresponding responses) with each of ILs 445 and 455 for accessing the corresponding target systems located within data centers 440 and 450 respectively. The access to target systems within data centers 440 and 450 may accordingly be managed independently by the respective line of business.

In a hybrid data center scenario, data center 410 belongs to an enterprise/organization, data center 420 belongs to a customer organization of the enterprise. The customer organization, in turn, has outsourced hosting of some of the resources and target systems to third-party partners having respective data centers 430 and 440. It may not be desirable (and in some cases, not feasible) to provide direct access to target systems within the partner data centers. For example, the partners may have agreements only with the customer and not the enterprise. IM 412 and ILs 422, 432 and 442 depict a deployment for the hybrid data center scenario. By deploying respective ILs 422, 432 and 442 in the customer and the two partner data centers, IM 412 is facilitated to manage the identity information without requiring direct access to the target systems in the partner data centers.

In a service provider scenario, an enterprises/organization (owning data center 410) offers outsourcing (of resources) services to different customers. Data centers 420 and 430 may accordingly belong to a first customer of the service provider, data center 450 may belong to a second customer, while data center 440 (belonging to the service provider or a partner organization) may host resources of both first and second customers. It may be desirable that the identity information of each customer be maintained independently. IMs 412 and 415 (along with respective ILs) depict a deployment for the service provided scenario. By having individual IMs that work with corresponding ILs deployed in specific data centers, the identity information of different customers is enabled to be maintained independently.

In a multi-tenancy scenario, the same data center (such as 430) hosts resources for multiple organizations. It may be desirable that the identity information of the different organizations be segregated. In such a scenario, multiple ILs 432 and 438 can be deployed in the data center with administrators of data center 430 then configuring the ILs to provide connection of the target systems of the corresponding organization. The IMs (such as 412 and 428) of the different organizations are accordingly allowed access to only the target systems of the respective organization.

It may be appreciated that in all the different deployments employed for the different scenarios noted above, the administration of access to target systems (maintaining identity information for a corresponding group of users) is decentralized. Each of the ILs is managed by the administrators of the corresponding data centers, with the IMs then interfacing with the ILs to access the desired target systems in such data centers.

It should be further appreciated that the features described above can be implemented in various embodiments as a desired combination of one or more of hardware, software, and firmware. The description is continued with respect to an embodiment in which various features are operative when the software instructions described above are executed.

### 8. Digital Processing System

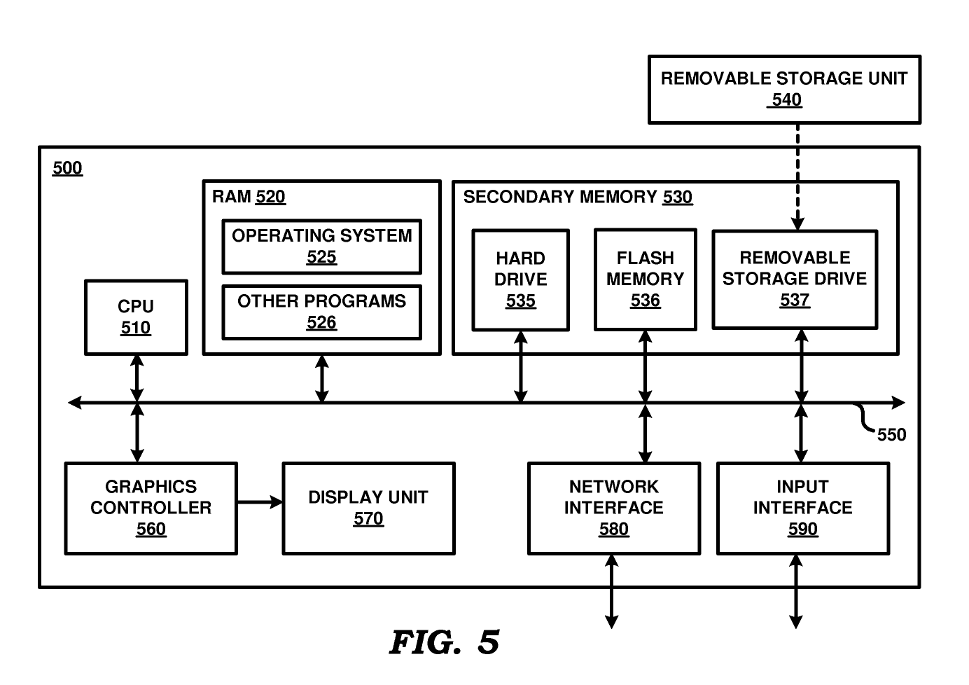

FIG. 5 is a block diagram illustrating the details of digital processing system 500 in which various aspects of the present invention are operative by execution of appropriate software instructions. Digital processing system 500 may correspond to identity link 250 or identity manager 270.

Digital processing system 500 may contain one or more processors such as a central processing unit (CPU) 510, random access memory (RAM) 520, secondary memory 530, graphics controller 560, display unit 570, network interface 580, and input interface 590. All the components except display unit 570 may communicate with each other over communication path 550, which may contain several buses as is well known in the relevant arts. The components of FIG. 5 are described below in further detail.

CPU 510 may execute instructions stored in RAM 520 to provide several features of the present invention. CPU 510 may contain multiple processing units, with each processing unit potentially being designed for a specific task. Alternatively, CPU 510 may contain only a single general-purpose processing unit.

RAM 520 may receive instructions from secondary memory 530 using communication path 550. RAM 520 is shown currently containing software instructions constituting operating system 525 and/or other code/programs 526 (such as client applications, Web browser, application instances processing client requests, RDBMS, etc.). In addition to operating system 525, RAM 520 may contain other software programs such as device drivers, virtual machines, etc., which provide a (common) run time environment for execution of other code/programs 526.

Graphics controller 560 generates display signals (e.g., in RGB format) to display unit 570 based on data/instructions received from CPU 510. Display unit 570 contains a display screen to display the images defined by the display signals. Input interface 590 may correspond to a keyboard and a pointing device (e.g., touch-pad, mouse) and may be used to provide inputs. Network interface 580 provides connectivity to a network (e.g., using Internet Protocol), and may be used to communicate with other systems (such as those shown in FIG. 1) connected to the network.

Secondary memory 530 may contain hard drive 536, flash memory 537, and removable storage drive 538. Secondary memory 530 may store the data (e.g., connector information such as the values of access parameters) and software instructions (e.g. for performing the actions of FIG. 3), which enable digital processing system 500 to provide several features in accordance with the present invention.

Some or all of the data and instructions may be provided on removable storage unit 539, and the data and instructions may be read and provided by removable storage drive 538 to CPU 510. Floppy drive, magnetic tape drive, CD-ROM drive, DVD Drive, Flash memory, removable memory chip (PCMCIA Card, EPROM) are examples of such removable storage drive 538.

Removable storage unit 539 may be implemented using medium and storage format compatible with removable storage drive 538 such that removable storage drive 538 can read the data and instructions. Thus, removable storage unit 539 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 539 or hard disk installed in hard drive 536. These computer program products are means for providing software to digital processing system 500. CPU 510 may retrieve the software instructions, and execute the instructions to provide various features of the present invention described above.

Reference throughout this specification to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment” and similar language throughout this specification may, but do not necessarily, all refer to the same embodiment.

Furthermore, the described features, structures, or characteristics of the invention may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the invention.

### 9. Conclusion

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

It should be understood that the figures and/or screen shots illustrated in the attachments highlighting the functionality and advantages of the present invention are presented for example purposes only. The present invention is sufficiently flexible and configurable, such that it may be utilized in ways other than that shown in the accompanying figures.

Further, the purpose of the following Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

APPENDIX A

| Resource | Uri Template |
|---|---|
| Server | / |
| Information | |
| HEAD | Returns meta-data about the OIL instance. For example, number of targets, number |
| | of operations executed, uptime, etc |
| Server | /ping |
| Availability | |
| HEAD | Returns a status with HTTP status code (200), if OIL Server is available. |
| Target | /ping/targets/{target_name} |
| Availability | |
| HEAD | Returns a target status with HTTP status code (200), if available. |
| Target List | /targets |
| GET | Returns a list of targets. Each item contains a target_name (and for convenience |
| | includes a link to “/targets/{target_name}”) |
| Target Schema | /targets/{target_name} |
| GET | Returns a list of object-classes that the connector supports for that target. |
| | Note: If a connector exposes a predefined attribute in its schema, it declares that it |
| | supports the semantic contract that accompanies the attribute. Client can make out |
| | of target's capabilities by looking at the schema. |
| Object List | /targets/{target_name}/{objClass} |
| GET | Returns a list of all objects of that object-class on that target. Clients use request- |
| | parameters to specify selection-criteria (e.g., search-filter). |
| | The return representation contains a list of uids. The selection criteria would be |
| | based the following request parameters, if present in the request : |

ICF Filter (it will be converted into URL-encoded string-format LDAP
search filters). The format of Filter's attribute value will be
<objectType>:“token value”.
ATTR_TO_GET (comma-separated list of attribute-names, and they will
be URL-encoded)
OperationOptions (comma-separated list of key-value pairs, and they will
be URL-encoded)

e.g.:“attr1”=<objectType>:“<value1>”,
. . . ,“attrn”=<objectType>:“<valuen>”

| | |
|---|---|
| | Note: First search call from client would have “attributesToGet” set to Uid only. |
| | The client needs to iterate over this list and do a GET for each Uid |
| POST | Creates an object (and lets the target assign the UID). The addition need |
| | information needs to be passed as follow: |

ATTR_TO_GET (comma-separated list of attribute-names, and they will
be URL-encoded)
OperationOptions (comma-separated list of key-value pairs, and they will
be URL-encoded).

e.g.:“attr1”=<objectType>:“<value1>”,
. . . ,“attrn”=<objectType>:“<valuen>”

| | |
|---|---|
| Object | /targets/{target_name}/{objClass}/{uid} |
| GET | Reads a specific object. |
| PUT | Update attributes of a specific object. The addition need information needs to be |
| | passed as follow: |

ATTR_TO_GET (comma-separated list of attribute-names, and they will
be URL-encoded)
OperationOptions (comma-separated list of key-value pairs, and they will
be URL-encoded).

e.g.: “attr1”=<objectType>:“<value1>”,
. . . ,“attrn”=<objectType>:“<valuen>”

| | |
|---|---|
| DELETE | Deletes a specific object. The addition need information needs to be passed as |
| | follow: |

ATTR_TO_GET (comma-separated list of attribute-names, and they will
be URL-encoded)
OperationOptions (comma-separated list of key-value pairs, and they will
be URL-encoded).

e.g.:“attr1”=<objectType>:“<value1>”,
. . . ,“attrn”=<objectType>:“<valuen>”

| | |
|---|---|
| Update List | /updates/targets/{target_name}/{objClass} |
| GET | Returns a list of all changed objects of that object-class on that target. Clients use |
| | request-parameters to specify selection-criteria (e.g., timestamp or sync-token). |
| | The return representation contains a list of uids (in form of SyncDelta metadata) to |
| | be updated. The selection criteria would be based the following request |
| | parameters, if present in the request: |

SYNC_TOKEN: Format is <objectType>:“token value” (it will be
converted into URL-encoded string).
ATTR_TO_GET (comma-separated list of attribute-names, and they will
be URL-encoded)
OperationOptions: (comma-separated list of key-value pairs, and they will
be URL-encoded).

e.g.:“attr1”=<objectType>:“<value1>”,
. . . ,“attrn”=<objectType>:“<valuen>”

| | |
|---|---|
| | Note: First Sync call from client would have “attributesToGet” set to Uid only. It |
| | will return a list of Sync Delta “header information” (SyncToken, SyncDeltaTypem |
| | current Uid, previous Uid, URI of Connector Object) and making the caller do a |
| | GET for each Uid (for create/update sync-delta-type). |
| Latest SyncToken | /context/targets/{target_name}/{objClass}/syncToken |
| GET | Returns the most recent SyncToken for object of this object-class on this target. |
| Script | /script/targets/{target_name} |
| POST | Executes on the target system or application the script that is specified by (or is |
| | supplied as) the body of the post. Returns the results of native execution. The |
| | addition need information needs to be passed as follow: |

ATTR_TO_GET (comma-separated list of attribute-names, and they will
be URL-encoded)
OperationOptions (comma-separated list of key-value pairs, and they will
be URL-encoded).

e.g.:“attr1”=<objectType>:“<value1>”,
. . . ,“attrn”=<objectType>:“<valuen>”

| | |
|---|---|
| Script | /script/connector/targets/{target_name} |
| POST | Executes on the connector (as configured for the target) the script that is specified |
| | by (or is supplied as) the body of the post. (Running on the connector means that |
| | the script can use resources—e.g., invoke methods on classes—that are available in |
| | the connector-bundle.) Returns the results of execution on the connector. The |
| | addition need information needs to be passed as follow: |

ATTR_TO_GET (comma-separated list of attribute-names, and they will
be URL-encoded)
OperationOptions (comma-separated list of key-value pairs, and they will
be URL-encoded).

e.g.: “attr1”=<objectType>:“<value1>”,
. . . ,“attrn”=<objectType>:“<valuen>”

What is claimed is:

1. A computing system comprising:
a plurality of target systems, each target system maintaining identity information for a corresponding group of users;
an identity manager providing centralized management of identity information maintained in said plurality of target system;
an identity link provided between said identity manager and said plurality of target systems, said identify link operable to:
receive from said identity manager, an action request for performing an action related to identity management, said action request being directed to a first target system of said plurality of target systems;
establish a connection with said first target system;
send data representing said action to said first target system on said connection and receive in response a result of performance of said action; and
forward to said identity manager, said result as a response to receipt of said action request.

2. The computing system of claim 1, wherein said identity link is further operable to:
maintain information on a plurality of connectors, each connector being required for connecting with a corresponding one of said plurality of target systems;
inspect said information to determine a first connector required for connecting with said first target system, said first connector being contained in said plurality of connectors,
wherein said identity link establishes said connection using said first connector.

3. The computing system of claim 2, wherein said information is inspected and said connection is established, in response to receiving of said action request.

4. The computing system of claim 3, wherein each of said plurality of connectors is implemented as a corresponding one of a plurality of executable modules, wherein said first connector is implemented as a first executable module of said plurality of executable modules,
wherein said identity link establishes said connection with said first target system and sends said data representing said action to said first target system by invoking procedures of said first executable module,
wherein said identity link receives said result of performance of said action as a result of invoking the procedures of said first executable module.

5. The computing system of claim 4, wherein said identity link receives said result of performance of said action according to a first format,
wherein said identity link converts said result from said first format to a second format and then forwards said result in said second format as said response to receipt of said action request.

6. The computing system of claim 2, further comprising a second plurality of target systems, each of said second plurality of target systems also maintaining identity information for corresponding groups of users,
wherein said identity manager also manages the identity information maintained in said second plurality of target systems,
wherein said plurality of target systems and said identity link are provided in a first data centre, wherein access to said plurality of target systems is administered by a first organization,
wherein said second plurality of target systems and said identity manager are provided in a second data centre, wherein access to said second plurality of target systems is administered by a second organization,
whereby the administration of access is decentralized to each organization of a corresponding data centre.

7. The computing system of claim 6, wherein said identity link receives said action request and forwards said response according to a first protocol,
wherein said identity link establishes said connection with said first target system, sends said data representing said action to said first target system and receives said result of performance of said action from said first target system according to a second protocol, said second protocol being different from said first protocol.

8. A method of facilitating an identity manager to provide centralized management of identity information, respective portions of the identity information being maintained in a plurality of target systems, said plurality of target systems being located in a first data center and said identity manager being located in a second data center, said method being performed in a identity link provided in said first data centre between said identity manager and said plurality of target systems, said method comprising:
receiving from said identity manager, an action request for performing an action related to identity management, said action request being directed to a first target system of said plurality of target systems;
establishing a connection with said first target system;
sending data representing said action to said first target system on said connection and receive in response a result of performance of said action; and
forwarding to said identity manager, said result as a response to receipt of said action request.

9. The method of claim 8, further comprising:
maintaining information on a plurality of connectors, each connector being required for connecting with a corresponding one of said plurality of target systems; and
inspecting said information to determine a first connector required for connecting with said first target system, said first connector being contained in said plurality of connectors,
wherein said establishing establishes said connection using said first connector.

10. The method of claim 9, wherein said inspecting said information and said establishing said connection are performed in response to said receiving of said action request.

11. The method of claim 10, wherein each of said plurality of connectors is implemented as a corresponding one of a plurality of executable modules, wherein said first connector is implemented as a first executable module of said plurality of executable modules,
wherein said establishing and said sending is performed by invoking procedures of said first executable module,
wherein said receiving from said first target system receives said result of performance of said action as a result of invoking the procedures of said first executable module.

12. The method of claim 11, wherein said receiving from said first target system receives said result of performance of said action according to a first format, said method further comprising:
converting said result from said first format to a second format,
wherein said forwarding forwards said result in said second format as said response to receipt of said action request.

13. The method of claim 8, wherein said second data center contains a second plurality of target systems, each of said second plurality of target systems also maintaining respective portions of the identity,
wherein said identity manager also manages the identity information maintained in said second plurality of target systems,
wherein access to said plurality of target systems is administered by a first organization and access to said second plurality of target systems is administered by a second organization,
whereby the administration of access is decentralized to each organization of a corresponding data centre.

14. The method of claim 13, wherein said receiving said action request from said identity manager and said forwarding said response to said identity manager are according to a first protocol,
wherein said establishing said connection with said first target system, said sending said data representing said action to said first target system and receiving said result of performance of said action from said first target system are according to a second protocol, said second protocol being different from said first protocol.

15. A non-transitory machine readable medium storing one or more sequences of instructions for causing a system to facilitate an identity manager to provide centralized management of identity information, respective portions of the identity information being maintained in a plurality of target systems, said plurality of target systems being located in a first data center and said identity manager being located in a second data center, said system being provided in said first data centre between said identity manager and said plurality of target systems, wherein execution of said one or more instructions by one or more processors contained in said system causes said system to perform the actions of:
receiving from said identity manager, an action request for performing an action related to identity management, said action request being directed to a first target system of said plurality of target systems;
establishing a connection with said first target system;
sending data representing said action to said first target system on said connection and receive in response a result of performance of said action; and
forwarding to said identity manager, said result as a response to receipt of said action request.

16. The machine readable medium of claim 15, further comprising one or more instructions for:
maintaining information on a plurality of connectors, each connector being required for connecting with a corresponding one of said plurality of target systems; and
inspecting said information to determine a first connector required for connecting with said first target system, said first connector being contained in said plurality of connectors,
wherein said establishing establishes said connection using said first connector.

17. The machine readable medium of claim 16, wherein said inspecting said information and said establishing said connection are performed in response to said receiving of said action request.

18. The machine readable medium of claim 17, wherein said receiving from said first target system receives said result of performance of said action according to a first format, further comprising one or more instructions for:
converting said result from said first format to a second format,
wherein said forwarding forwards said result in said second format as said response to receipt of said action request.

19. The machine readable medium of claim 15, wherein said second data center contains a second plurality of target systems, each of said second plurality of target systems also maintaining respective portions of the identity,
wherein said identity manager also manages the identity information maintained in said second plurality of target systems,
wherein access to said plurality of target systems is administered by a first organization and access to said second plurality of target systems is administered by a second organization,
whereby the administration of access is decentralized to each organization of a corresponding data centre.

20. The machine readable medium of claim 19, wherein said receiving said action request from said identity manager and said forwarding said response to said identity manager are according to a first protocol,
wherein said establishing said connection with said first target system, said sending said data representing said action to said first target system and receiving said result of performance of said action from said first target system are according to a second protocol, said second protocol being different from said first protocol.
